(19) United States
(12) Patent Application Publication
(10) Pub. No.: US 2024/0359890 A1
(43) Pub. Date: Oct. 31, 2024

(54) RECYCLABLE FOOD PACKAGING

(71) Applicant: TRILLION CREATIVE LIMITED, Hong Kong (HK)

(72) Inventor: Jianhong Wang, Hong Kong (HK)

(73) Assignee: TRILLION CREATIVE LIMITED, Hong Kong (HK)

(21) Appl. No.: 18/520,225

(22) Filed: Nov. 27, 2023

(30) Foreign Application Priority Data
Nov. 26, 2022 (CN) 202211494868.2

(51) Int. Cl. B65D 65/38; B65D 5/60

(52) U.S. Cl. CPC B65D 65/38; B65D 5/606; B65D 2203/02; B65D 2565/385

(57) ABSTRACT

A packaging box includes an outer paper shell and an inner film. At least one edge of the inner film includes a first adhesive portion to be bonded with the outer paper shell. A perforation line or area is disposed on the outer paper shell. The inner film also includes a second adhesive portion, and the second adhesive portion surrounds the perforation line and bonds with the outer paper shell. A covering is disposed at the outside of the outer paper shell to cover the perforation line.

### CROSS-REFERENCE TO RELATED APPLICATION

This application claims priority to Chinese application numbers 202211494868.2, filed on Nov. 26, 2022, and 202311596709.8 filed on Nov. 27, 2023, which are incorporated by reference in their entirety.

### TECHNICAL FIELD

Embodiments of the invention relate to the field of packaging materials. In particular, aspects of the invention relate to a packaging box that is convenient for recycling.

### BACKGROUND

Packaging boxes, especially flexible packaging boxes for beverages, refer to the use of appropriate materials, containers, processes, structural design and other means to wrap and decorate beverages and to maintain the quality of beverages or increase their commodity value in the processing, transportation, storage and sales of beverages.

In the known art, there exist environmentally friendly packaging boxes that may include a packaging film and a wrapping paper. The packaging film and the wrapping paper are arranged to form a direct face-to-face relationship with each other, and the four edges of the packaging film are bonded and fixed with the four edges of the wrapping paper completely. The prior technology also teaches that in the parts where the wrapping paper is not bonded and fixed with the packaging film, the wrapping paper is separated from the packaging film, and a plurality of tearing lines set by perforation lines are cut on the wrapping paper. Also, the prior technology specifies that the tearing lines extend to the four edges of the packaging film and the wrapping paper, and the cavity between the packaging film and the wrapping paper communicates with the cutting holes of the perforation line. In the process of subsequent recycling, the wrapping paper and the packaging film are torn from the tear line, thus facilitating recycling.

However, the prior technology still has serious defects. For example, the packaging box needs to be soaked in the disinfectant bath for at least five seconds to be sanitized before filling the content thereof. Although in this short soaking time, the disinfectant will enter the cavity through the cutting hole, which will cause the spaces between the packaging film and the wrapping paper to come in contact with the disinfectant. This will seriously result in the softening of the packaging paper after being soaked in the disinfectant, while affecting the integrity and hardness of the flexible packaging box, resulting in the increase of defective products and content thereof.

The technical problem to be solved by aspects of the invention include how to avoid the disinfectant solution from entering the cavity between the outer paper shell and the inner lining or membrane during the disinfection process, improve the stability of the quality of the flexible packaging box, while continue to maintain the function of convenient recycling.

### SUMMARY

Aspects of the invention overcome the deficiencies of the prior art by providing a packaging box that is convenient for recycling, with the outer paper shell and the inner lining or membrane being easily separated from one another. Embodiments of the invention further may prevent water vapor from entering the gap or cavity between the outer paper shell and the inner membrane or lining.

Embodiments of the invention include: a packaging box that is convenient for recycling comprises an outer paper shell and an inner membrane or liner. In one aspect, the edge of the inner membrane includes a first adhesive part. In one embodiment, the first adhesive part bonds with the outer paper shell while a perforated line is disposed on the outer paper shell. In one aspect, the perforated line may be disposed in the area enclosed by the first adhesive part. In one aspect, the inner membrane may also include a second adhesive part, the second adhesive part may include a perforated line, and the second adhesive part may be bonded and fixed with the outer paper shell.

In another embodiment, aspects of the invention may comprise the outer paper shell with a covering to cover the perforated line, such that the inner membrane does not need to be bonded with a second adhesive part.

In one embodiment, the packaging box may be convenient for recycling and may include a first adhesive part at the edge of the inner membrane, that is, only a small part of the area position or position of the inner membrane and the outer paper shell is in the laminating state, and the position of most other areas is in the state of separation, so that the inner membrane is separated from the outer paper shell when the packaging box is recycled in the later stage, and the amount of adhesive is reduced, and the environmental protection is more;

In addition, in order to facilitate the recycling and separation of the inner membrane and the outer paper shell, a perforation line may be arranged on the outer paper shell, and the outer paper shell may be torn along the perforated line during recycling, so that the inner membrane and the outer paper shell may be separated subsequently, so as to properly recycle the outer paper shell.

In another embodiment, a second adhesive part may be arranged around the perforated line, so that the inner membrane and the inner wall of the outer paper shell around the perforated line are in a state of bonding. In one aspect, the state of bonding may effectively prevent water vapor from entering the inside of the outer paper shell through the perforated line. In one aspect, embodiments of the invention attempt to avoid the outer paper shell being soaked and softened, and improve the yield rate of the packaging box.

In some embodiments, the second adhesive part may be arranged along the trajectory or path of the perforated line, and the second adhesive part may cover the perforated line. In another embodiment, this arrangement may further reduce the contact area between the second adhesive part and the inner wall of the outer paper shell, and reduce the difficulty of tearing the outer paper shell from the perforated line.

In some embodiments, the second adhesive part may be a closed loop, and a perforated line may be arranged in the loop. In one aspect, the second adhesive part may be arranged at the periphery of the perforation line, and the adhesive may not directly cover the perforated line, which may be convenient for tearing the outer paper shell, and may also limit the water vapor invaded by the outside world in the circle formed by the second adhesive part. In one aspect, the amount of water vapor intrusion is limited, and may not affect the overall structure of the packaging box.

In some embodiments, a perforated line may extend from the top edge of the outer paper shell or adjacent to the top edge to the bottom edge or near the bottom edge. In this setting, the outer paper shell may be torn apart by a perforated line similar to a book, and the outer paper shell and the inner membrane may be easily separated from the torn outer paper shell.

In some embodiments, the perforated line does not need to communicate with the edge of the outer paper shell. In this way, the length or shape of the perforated line may be designed at will, so that the outer paper shell may be torn more thoroughly, and the force of the perforated line may also be improved, and to avoid the packaging box being pressed and cracking directly along the perforated line during transportation.

In some embodiments, the punch line may be set anywhere on the outer paper shell, such as at a corner or adjacent to a corner. In this way, the outer paper shell may be torn from the corner of the outer paper shell along the perforation line, and the finger may be stretched into the outer paper shell from the hole of the perforated line to pinch the corner of the inner membrane, and the inner membrane may be pinched with a smaller opening, so that the inner membrane and the outer paper shell may be separated.

In some embodiments, a perforated line may be arranged in the middle of an outer paper shell.

In some embodiments, in a way that reduces the amount of adhesive even more, a covering may be arranged on the outside of the outer paper shell to cover the perforated line, so that the inner membrane does not need to be provided with a second adhesive part.

In some embodiments, the covering may be a sticker.

In some embodiments, the sticker may tear the outer paper shell (10) along the perforated line (11) when removed.

In some embodiments, the box cover may be also included, and the box cover may be connected with the outer paper shell, and the outer paper shell may be provided with a through hole corresponding to the box cover.

In some embodiments, the inner membrane further may comprise a third adhesive part, the third adhesive part encloses a through hole, and the third adhesive part is bonded and fixed with the outer paper shell. It acts as a support for the straw inserted through the hole. By setting up the third adhesive part, the strength of the inner membrane around the through hole may be improved, and the inner membrane around the through hole may be prevented from leaking between the inner membrane and the outer paper shell when the beverage is sucked or poured.

In some embodiments, the present invention further comprises a fourth adhesive part, which may be shaped as a square or other shape, in the middle part of the inner membrane or scattered in the middle position, mainly to maintain the shape of the inner membrane and the outer paper folded into a box, and to avoid the displacement or sliding of the inner membrane.

In some embodiments, the outer paper shell may be rectangular after unfolding with the inner membrane, and creases may be arranged on the outer paper shell. By setting the crease, it is easy to fold the outer paper shell in the unfolded state into a box.

The beneficial effects of the present invention are as follows: the packaging box of the embodiments of the present application for easy recovery may be provided with a second adhesive part corresponding to the perforated line on the inner membrane, so that the inner wall of the outer paper shell around the perforated line and the inner membrane are in a bonded and fixed state, effectively preventing the water vapor from invading into the outer paper shell through the perforated line during the sanitizing process and the refrigeration process, resulting in the softening of the outer paper shell, and ensuring the hardness of the outer paper shell while making the inner membrane and the outer paper shell easy to separate for sorting and recycling

### BRIEF DESCRIPTION OF THE DRAWINGS

FIG. 1 is a schematic diagram of the structure of the packaging box that is convenient for recycling of the first embodiment of the present invention;

FIG. 2 is a schematic diagram of the structure of the state of tearing along the perforated line of the packaging box that is convenient for recycling shown in FIG. 1;

FIG. 3 is a schematic diagram of the structure of the outer paper shell and the inner membrane of the packaging box that is convenient for recycling shown in FIG. 1;

FIG. 4 is the schematic diagram of the structure of the outer paper shell unfolding state shown in FIG. 3;

FIG. 5 is a schematic diagram of one of the structures of the perforated line of the packaging box that the present invention is convenient for recycling;

FIG. 6 is another schematic diagram of one of the structures of the perforated line of the packaging box that the present invention is convenient for recycling;

FIG. 7 is a schematic diagram of one of the structures of the packing box perforated line that the present invention is convenient for recycling; and

FIG. 8 is a schematic diagram of the structure of the outer paper shell and the inner membrane unfolding state of the packaging box that is convenient for recycling of the second embodiment of the present invention.

In the figures: 100, the packaging box that is convenient for recycling; 10, the outer paper shell; 11, the perforated line; 12, the through hole; 13, the crease; 20, the inner membrane; 21, the first adhesive part; 22, the separation portion; 23, the second adhesive part; 24, the third adhesive part; 26, the covering; 30, the box cover.

### DETAILED DESCRIPTION

It is important to note that when a component is said to be “fixed” to another component, it may be directly on top of the other component or it may be centered on the component. When a component is considered to be “connected” to another component, it may be either directly connected to another component or there may be a centered component at the same time. When the number of a component is said to have “many”, it may be any number of two or more. The terms “vertical”, “horizontal”, “left”, “right” and similar expressions used herein are for illustrative purposes only and are not intended to be the sole means of implementation.

Unless otherwise defined, all technical and scientific terms used herein have the same meanings as generally understood by those skilled in the art of the present invention. The terms used in the description of the present invention herein are for the purpose of describing specific embodiments only and are not intended to limit the present invention. As used herein, the term “and/or” includes any and all combinations of one or more related listed items.

### The First Embodiment

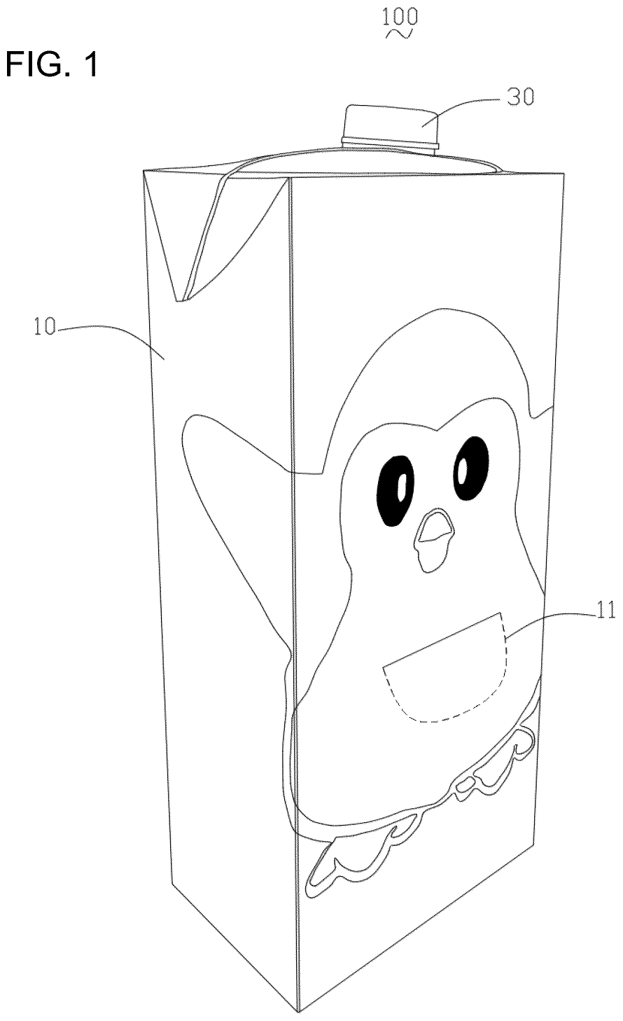

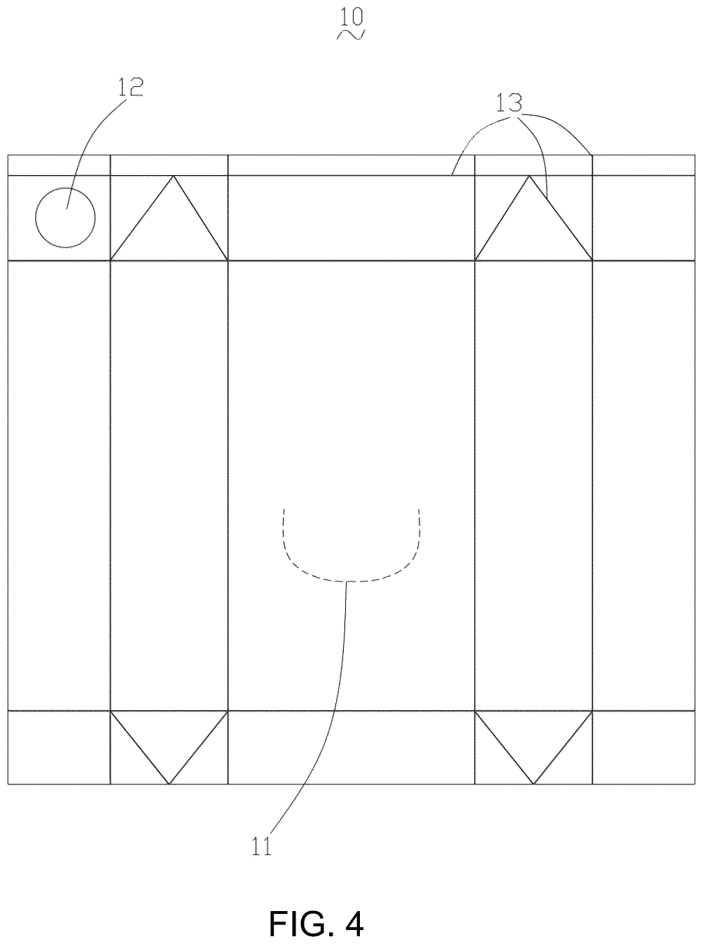

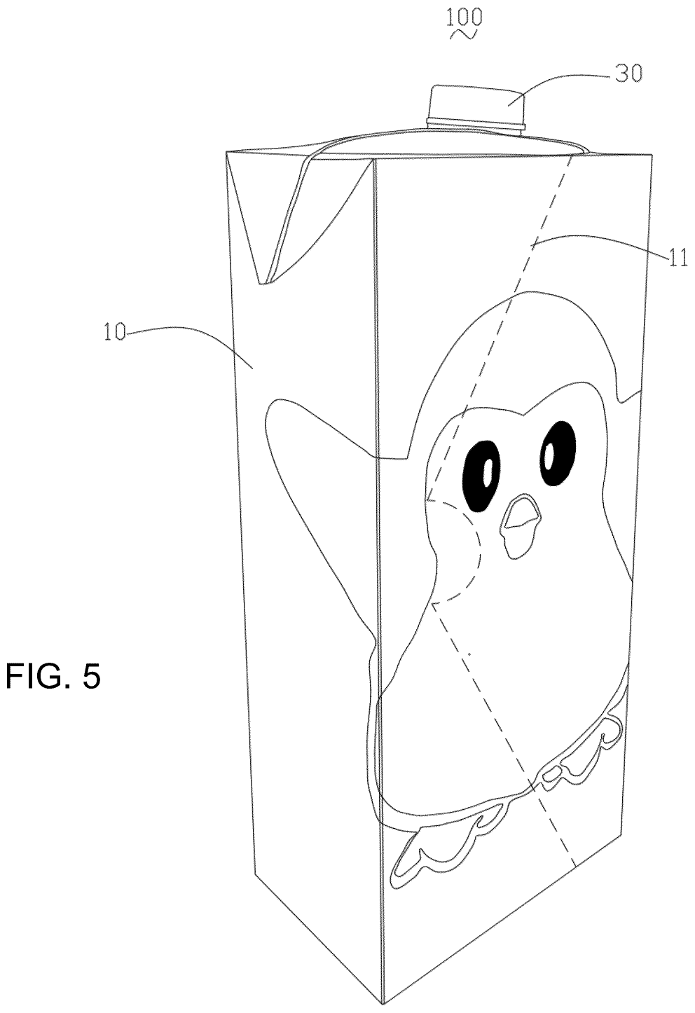

Refer to FIG. 1 and FIG. 4, a packaging box 100, that is convenient for recycling may embody aspects of embodiment of the present invention, comprises an outer paper shell 10 and an inner membrane 20 built into the outer paper shell 10, the inner membrane 20 comprises a first adhesive part 21 and a separating portion 22, the first adhesive part 21 is arranged at the edge of the inner membrane 20, for example, the first adhesive part may be continuous, intermittent, intricate, etc., and the edge width may be adjusted according to the packaging size requirements. The first adhesive part 21 may be bonded and fixed with the outer paper shell 10, the first adhesive portion 21 encloses a separating portion 22, the separating portion 22 is not bonded with the outer paper shell 10, and a perforated line 11 is arranged on the outer paper shell 10. The packaging box 100 that is convenient for recycling of the present application may be provided with a first adhesive part 21 at the edge of the inner membrane 20. In one aspect, only a small part of the area position of the inner membrane 20 and the outer paper shell 10 is in a state of lamination, and the position of most other areas is in a state of separation, so that the inner membrane 20 and the outer paper shell 10 are separated when the packaging box is recycled in the later stage, and the amount of adhesive is reduced, and more environmental protection.

To facilitate the recovery and separation of the inner membrane 20 and the outer paper shell 10, a perforation line 11 may be arranged on the outer paper shell 10, and the outer paper shell 10 may be torn along the perforated line 11 during recycling, so that the inner membrane 20 and the outer paper shell 10 are separated subsequently, so that the classification and recycling are realized.

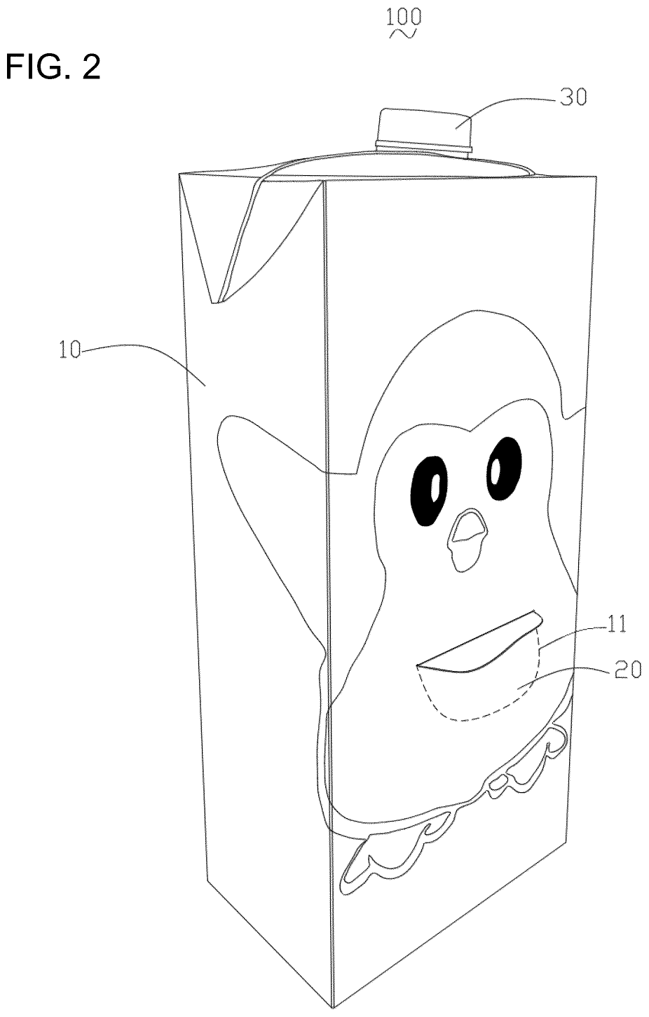

For example, the trajectory of the perforated line 11 may be made in any design or modeling. In one aspect, for example, FIG. 1 to FIG. 4 and FIG. 8 are arc-shaped line displays, and the perforated line 11 is set to arc-shaped line, so that the edge of the outer paper shell 10 may be relatively smooth when it is torn along the perforated line 11, so as to avoid scratching the operator when extracting the inner membrane 20. It should be noted that the trajectory of the perforated line 11 is not limited to the shape shown in the curve or the accompanying drawing, and the trajectory of the perforated line 11 may be designed according to the shape of the packaging box, the actual situation of the structure, and only needs to meet the purpose that the outer paper shell 10 may be conveniently torn apart, and the inner membrane 20 is extracted from the inside of the outer paper shell 10.

As shown in FIG. 1, the perforated line 11 may be arranged in the middle part of the outer paper shell 10, and the perforated line 11 is arc-shaped. Because the inner membrane is in a taut state when the outer paper shell 10 is upright, when separating the outer paper shell 10 and the inner membrane 20, in order to facilitate the pinching of the inner membrane 20, in the case of the perforation line 11 shape shown in FIG. 1, the outer paper shell 10 should be compressed in the height direction, so that the inner membrane 20 produces folds, so as to facilitate pinching. In some embodiments, when the perforated line 11 is arranged in the middle part of the outer paper shell 10, the perforated line 11 is arranged in the middle and lower part of the outer paper shell 10. Because after the packaging box pours out a part of the drink, the upper part of the packaging box is in a hollow state, at this moment, the middle and upper part of the packaging box is pinched, the middle and upper part of the packaging box is easily deformed, if the perforated line 11 is arranged in the middle and upper part of the outer paper shell 10, after pouring out a part of the drink, the outer paper shell 10 may be cracked and damaged at the perforated line 11 when the middle and upper part of the outer paper shell 10 is pinched, and the pouring of the beverage is affected.

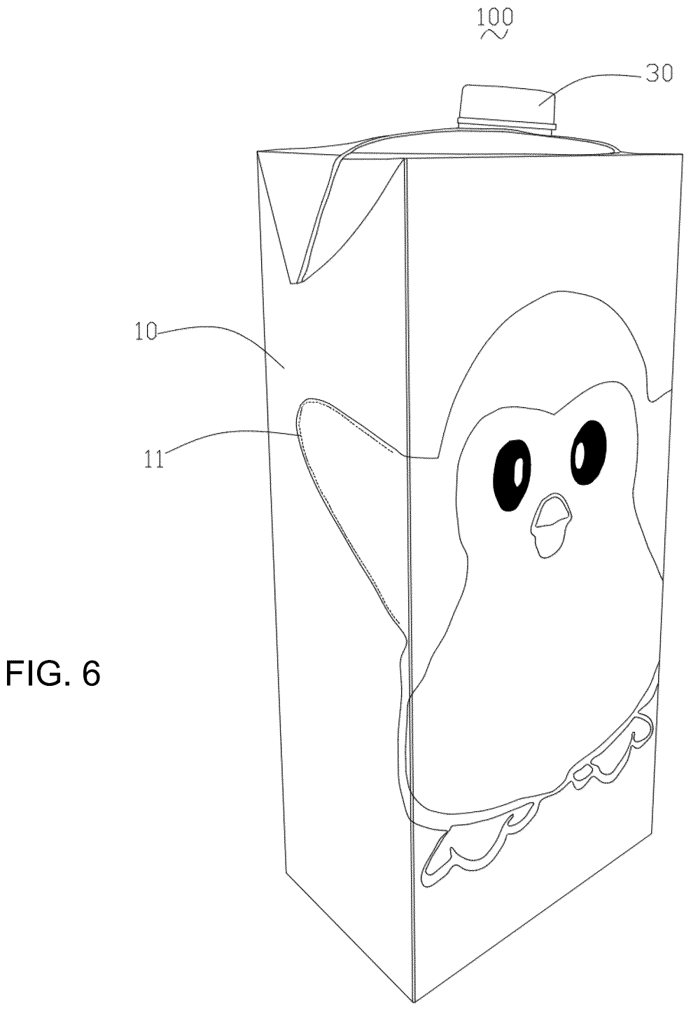

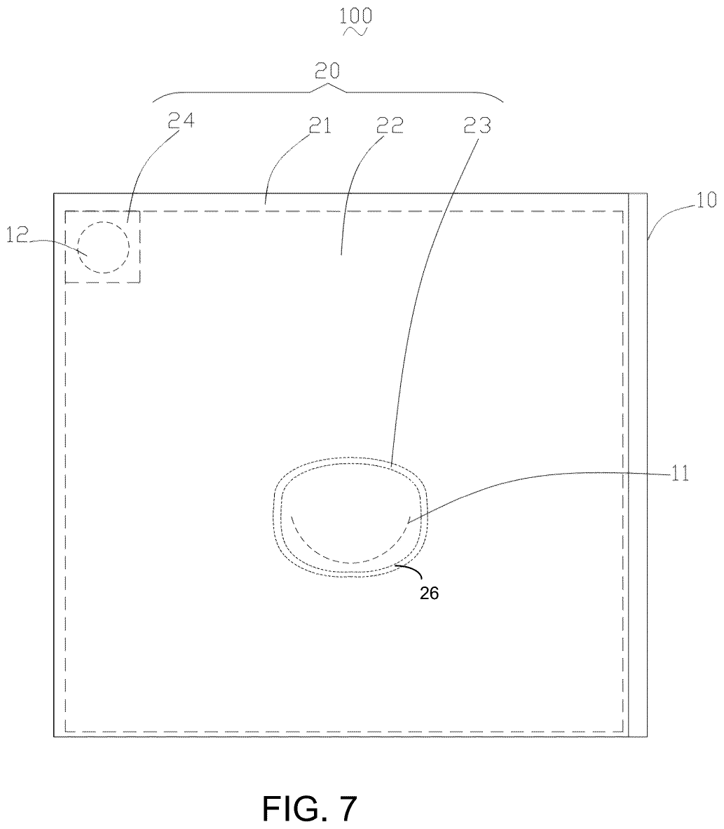

As shown in FIG. 6 and FIG. 7, another structural schematic diagram of perforated line 11, and perforated line 11 may be arranged at the corner of outer paper shell 10 or the position adjacent to the corner. In this way, the outer paper shell 10 may be torn apart from the corner of the outer paper shell 10 along the perforated line 11, the finger may be stretched into the outer paper shell 10 from the hole of the perforated line 11 and the corner of the inner membrane 20 may be pinched, the inner membrane 20 may be pinched with a smaller opening, and the inner membrane 20 may be extracted.

Because in the process of sanitizing the packaging box and when refrigerated in the refrigerator, there will be the possibility that water vapor enters the inside of the outer paper shell 10 through the hole of the perforated line 11, and when the water vapor invades the inside of the outer paper shell 10, the outer paper shell 10 will be softened due to moisture, and in serious cases, it will also cause the outer paper shell 10 to break, seriously affecting the performance of the packaging box. In this regard, in order to prevent water from entering the perforated line 11, the inner membrane 20 further comprises a second adhesive part 23, the second adhesive part 23 encloses a perforated line 11, and the second adhesive part 23 may be bonded and fixed with the outer paper shell 10. a second adhesive portion 23 may be arranged around the perforated line 11, so that the inner membrane 20 and the inner wall of the outer paper shell 10 around the perforated line 11 are in a state of bonding, and the water vapor may be effectively prevented from entering the inside of the outer paper shell 10 through the perforated line 11, so that the outer paper shell 10 is prevented from being soaked and softened, and the yield rate of the packaging box is improved.

The structure of the perforated line 11 shown in FIG. 1 may be used as an example to introduce the second adhesive section 23. the second adhesive part 23 may be arranged along the trajectory of the perforated line 11, and the second adhesive part 23 covers the perforated line 11. This arrangement can reduce the contact area between the second adhesive part 23 and the inner wall of the outer paper shell 10, and reduce the difficulty of tearing the outer paper shell 10 from the perforation line 11.

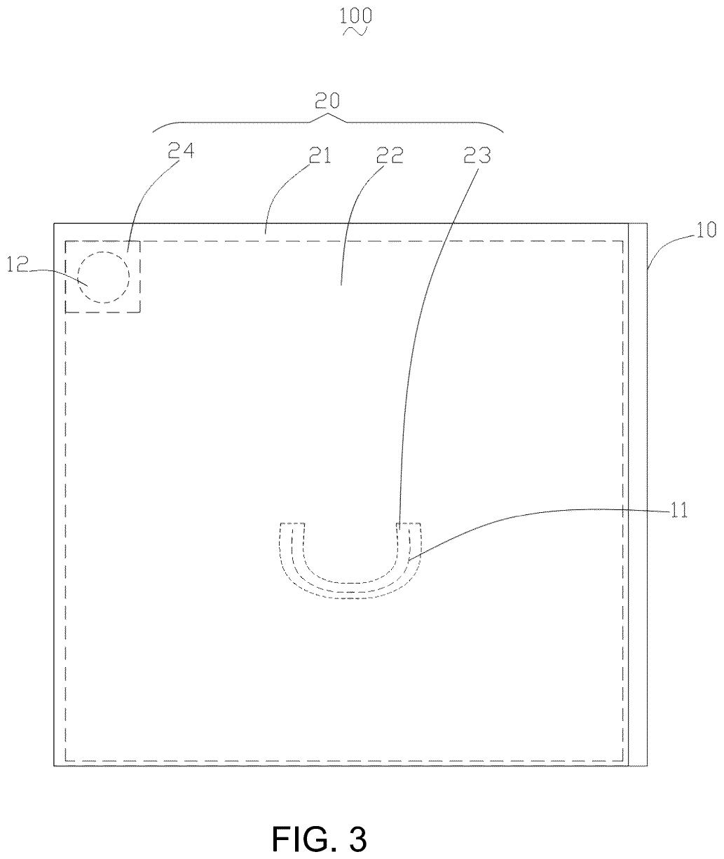

Refer to FIG. 3 and FIG. 4, the outer paper shell 10 and the inner membrane 20 are rectangular after unfolding, and the outer paper shell 10 may be provided with crease 13. By setting crease 13, the outer paper shell 10 that is in the unfolded state may be conveniently folded into a box body.

In order to prevent the perforated line 11 from influencing the appearance of the packaging box, a pattern may be arranged on the outer surface of the outer paper shell 10, and then the perforated line 11 may be set along the contour of the pattern, so that the perforated line 11 may be visually hidden, and the appearance aesthetic of the packaging box may be enhanced.

Optionally, the width of the first adhesive part 21 may be 5 mm˜30 mm. The adhesive may be completely covered or indirectly, or there are arranged matrices, etc. The first adhesive part 21 should be in the packaging inner membrane 20 and the outer paper shell 10 at the same time, as far as possible to save the amount of adhesive used, but also should consider the convenience of separating the inner membrane 20 and the outer paper shell 10 in the later stage, so as to facilitate sorting and recycling. Preferably, the width of the part of the first adhesive part 21 close to the top of the outer paper shell 10 may be greater than the width of the other part. Because the first adhesive part 21 close to the top of the outer paper shell 10 also needs to bear the gravity force after filling the beverage, increasing the width of the first adhesive part 21 here, may be conducive to improving the strength of the inner membrane 20, preventing the inner membrane 20 from falling off after filling the beverage.

In this embodiment, the packaging box 100 convenient for recycling further comprises a box cover 30, the box cover 30 may be connected with the outer paper shell 10, and the outer paper shell 10 may be provided with a through hole 12 corresponding to the box cover 30. Correspondingly, the inner membrane 20 further comprises a third adhesive part 24, the third adhesive part 24 encloses a through hole 12, and the third adhesive part 24 may be bonded and fixed with the outer paper shell 10. By arranging the third adhesive part 24, the strength of the inner membrane 20 around the through hole 12 may be improved, and the inner membrane 20 around the through hole 12 may be prevented from falling off when sucking or pouring the drink, and the beverage leaks between the inner membrane 20 and the outer paper shell 10. In an embodiment, the through hole 12 may be a channel for the user to insert a straw, so that the third adhesive part 24 can maintain the support of the through hole 12. In another embodiment, within the range of the third adhesive portion 24 or through hole 12, a shaped colored glue, such as an isosceles right triangle, may be coated at the corresponding position of the inner membrane. It is convenient to observe the perforated holes on the outer paper shell, so as to quickly check whether the inner membrane may be aligned with the outer paper sleeve in the production process, and there is no need to stop for detection, which greatly improves the production efficiency. In addition, optionally, the width of the third adhesive part 24 may be 10 mm˜20 mm.

The inner membrane 20 comprises a PE layer, an aluminum foil layer and a PET layer that are successively compounded from the inside to the outside, and the PET layer and the outer paper shell 10 form a direct face-to-face relationship with each other. Preferably, the thickness of the PE layer may be 5-15 μm, the thickness of the aluminum foil layer may be 6-9 μm, and the thickness of the PET layer may be 10˜18 μm. The PE layer may be the extruded low-density polyethylene layer, which may be in direct contact with the beverage, and has adaptability, permeation resistance, good heat sealability, etc.; the aluminum foil layer mainly plays the role of blocking and protecting from light, so as to avoid the beverage from being affected by ultraviolet rays in the light; the PET layer may be the polyethylene terephthalate layer, which makes the gas and water vapor permeability low, has excellent gas blocking, water, oil and odor properties, and has good temperature resistance.

As a further improvement, the inner membrane 20 also includes a PA layer, and the PA layer may be composite between the aluminum foil layer and the PET layer, and the thickness of the PA layer may be 12˜16 μm. The PA layer, also known as the nylon layer, can enhance the toughness of the inner membrane 20 and reduce the problem of internal membrane 20 rupture caused by external impact.

In the actual production process, because the beverage packaged in the packaging box needs to be placed in a humid refrigeration environment, therefore, the one side that the outer paper shell 10 may be far away from the inner membrane 20 may be coated with a transparent waterproof coating, and the waterproof coating covers the surface of the outer paper shell, and the waterproof effect may be realized.

The application discloses by arranging the first adhesive part 21, the second adhesive part 23 and the third adhesive part 24 on the inner membrane 20, through the gluing composite equipment for one-time gluing compounding, after the inner membrane 20 may be compounded with the outer paper shell 10, and then folded into a packaging box, without additional process, under the premise that the production cost may be basically unchanged, the inner membrane 20 and the outer paper shell 10 may be easily separated and recycled while ensuring the hardness of the outer paper shell 10.

### Second Embodiment

Referring to FIG. 8, the packaging box 100 convenient for recycling of the second embodiment of the present invention, the present embodiment may be similar to the first embodiment, except that the structure of the second adhesive part 23 in the present embodiment may be different. The second adhesive part 23 may be a closed circle, and the perforated line 11 may be arranged in the circle. The outer paper shell 10 in the circle enclosed by the second adhesive part 23 may be not adhered to the inner membrane 20, the second adhesive part 23 may be arranged at the periphery of the perforated line 11, the adhesive does not directly cover the perforated line 11, may be convenient for tearing the outer paper shell 10, and can also limit the water vapor invaded by the outside world in the circle enclosed by the second adhesive part 23, so that the amount of water vapor intrusion is limited, and does not affect the overall structure of the packaging box.

Finally, it should be noted that the foregoing is only a preferred example of the present invention and is not intended to limit the present invention, and although the present invention is described in detail with reference to the foregoing embodiments, a person skilled in the art may still modify the technical solutions described in the foregoing embodiments, or replace some of the technical features therein. Any modification, equivalent replacement, improvement, etc., made within the spirit and principles of the present invention shall be included in the scope of protection of the present invention.

What is claimed is:

1. The packaging box (100) convenient for recycling comprising:
an outer paper shell (10) and an inner membrane (20) built into the outer paper shell (10);
wherein the inner membrane (20) comprises at least an edge in contact with a first adhesive part (21), wherein the first adhesive part (21) is bonded and fixed with the outer paper shell (10);
a perforated line (11) is disposed on the outer paper shell (10), and the perforated line (11) is disposed in the area enclosed by the first adhesive part (21);
wherein the perforated line (11) is absent from the inner membrane (2);
wherein the inner membrane (20) further comprising a second adhesive part (23), wherein the second adhesive part (23) encloses a perforated line (11), and the second adhesive part (23) is glued and fixed to the outer paper shell (10).

2. The packaging box (100) convenient for recycling according to claim 1, wherein the second adhesive part (23) is arranged along the trajectory of the perforated line (11), and the second adhesive part (23) is covered with the perforated line (11).

3. The packaging box (100) convenient for recycling according to claim 1, wherein the second adhesive part (23) is a closed circle, and the perforated line (11) is arranged in the circle.

4. The packaging box (100) convenient for recycling according to claim 1, wherein the perforated line (11) is arranged in the middle part of the outer paper shell (10).

5. The packaging box (100) convenient for recycling according to claim 1, further comprising a box cover (30), the box cover (30) is connected with the outer paper shell (10), and the outer paper shell (10) is provided with a through hole (12) corresponding to the box cover (30).

6. The packaging box (100) convenient for recycling according to claim 1, wherein the inner membrane (20) further comprising a third adhesive part (24), the third adhesive part (24) encloses a through hole (12), and the third adhesive part (24) is bonded and fixed with the outer paper shell (10).

7. The packaging box (100) convenient for recycling according to claim 1, wherein the outer paper shell (10) and the inner membrane (20) are rectangular after being expanded, and a crease (13) is arranged on the outer paper shell (10).

8. A packaging box (100) convenient for recycling, comprising:
an outer paper shell (10) and an inner membrane (20) built into the outer paper shell (10);
wherein the inner membrane (20) comprises at least one edge with a first adhesive part (21);
wherein the first adhesive portion (21) is bonded and fixed with the outer paper shell (10);
a perforated line (11) is disposed on the outer paper shell (10), and the outer paper shell (10) comprises a covering (26) to cover the perforated line (1 1) around the perforated line (11).

9. The packing box (100) convenient for recycling as claimed in claim 8, wherein the covering (26) comprises a sticker.

10. The packaging box (100) convenient for recycling according to claim 9, wherein the outer paper shell (10) is removed along the perforated line (11) when the sticker is removed.

11. The packaging box (100) convenient for recycling according to claim 8, wherein the perforated line (11) is disposed in the middle part of the outer paper shell (10).

12. The packaging box (100) convenient for recycling according to claim 8, further comprising a box cover (30), the box cover (30) is connected with the outer paper shell (10), and the outer paper shell (10) is provided with a through hole (12) corresponding to the box cover (30).

13. The packaging box (100) convenient for recycling according to claim 8, wherein the inner membrane (20) further comprising a third adhesive part (24), the third adhesive part (24) encloses a through hole (12), and the third adhesive part (24) is glued and fixed with the outer paper shell (10).

14. The packaging box (100) convenient for recycling according to claim 8, wherein the outer paper shell (10) and the inner membrane (20) are rectangular after being expanded, and a crease (13) is disposed on the outer paper shell (10).
